(19) United States
(12) Patent Application Publication
(10) Pub. No.: US 2002/0087228 A1
(43) Pub. Date: Jul. 4, 2002

(54) Installation of control code for assembling mail pieces

(76) Inventor: Jelle Wiersma, Drachster (NL)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 10/028,332

(22) Filed: Dec. 28, 2001

(30) Foreign Application Priority Data
Dec. 30, 2000 (NL) 1017015

(51) Int. Cl. G06F 19/00

(52) U.S. Cl. 700/95; 700/96

(57) ABSTRACT

A method for arranging a control unit for controlling the assembly of mail pieces. The control unit is communicatively linked to a device for performing at least one operation for assembling mail pieces. The device transmits control code specific for the control of that device to the control unit. This control code is then installed on the control unit. Also described are a device and a combination of a device with program code, both specifically adapted for practicing the proposed method.

### FIELD AND BACKGROUND OF THE INVENTION

The invention relates to a system for arranging a control unit for controlling the assembly of mail pieces. The invention further relates to a device for use with that method, and to a combination of such a device with computer software.

In the field of peripheral equipment for personal computers, it is known that peripheral equipment connected to a personal computer is detected and recognized. In response thereto, control code for controlling that equipment is automatically installed on the computer system. In order to have this proceed fully automatically, control code for controlling a large variety of devices is supplied standard along with the operating system of the computer system. If a device for which no suitable control code is present on the computer system is being connected, the computer system asks the user for that control code. This control code is then to be transferred to the computer system from, for instance, a diskette or a CD-ROM disk or via a telecommunication link.

Devices for assembling mail pieces are manufactured in relatively small numbers and moreover have a large variety of designs. It is therefore not attractive to include control code for such a device in standard operating software for a computer system. Also when special operating systems built into mail assembly equipment itself, which are specifically intended for controlling exchangeable stations of that mail assembly equipment are involved, it is problematic to priorly input control code for all possible stations. Moreover, in this manner, no provisions can be made for future new control code for stations yet to be designed, which, for instance, can fulfill new functions.

Separate supply of such control code entails the disadvantage that it requires coordination to add the correct control code to the correct equipment. For the user, it is laborious to manage the control code for the various equipment, and when the correct control code for a particular device is lost, it is laborious to procure the correct control code again.

### SUMMARY OF THE INVENTION

It is an object of the invention to simplify the provision of the control code to be installed associated with a device to be connected to a control unit, for performing operations for the purpose of the assembly of mail pieces.

This object is achieved according to the present invention by providing a method for arranging a control unit for controlling the assembly of mail pieces, comprising: communicatively linking a device for performing at least one operation for the assembly of mail pieces to the control unit; said device transmitting control code specific to that device to the control unit; and installing said control code on the control unit. The invention further provides a device for physically processing postal components for the assembly of mail pieces, comprising: a control unit for controlling at least one processing operation for the assembly of mail pieces, provided with an interface for connection to an interface of a control unit; and a memory containing: code for transferring, from said memory to said control unit according to a communication protocol, data, control code specific for control of the device by a control unit, and control code arranged for control by a control unit in accordance with said control code installed on said control unit. This device is specifically arranged for practicing the method according to the invention in cooperation with a control unit to which the device is connected. Further, the invention provides a combination which, in addition to a device according to the invention, comprises generic computer software for arranging a control unit for cooperation with various devices according to the invention having different associated control code files.

As the control code which is specific to a device, or at least to devices of the type in question, is transferred from the device connected to the control unit, to the control unit, the control code does not need to be present beforehand or to be separately supplied along with the deuce.

Particularly advantageous embodiments of the invention are laid down in the depending claims.

The invention is further illustrated and elucidated on the basis of an exemplary embodiment with reference to the drawing.

### BRIEF DESCRIPTION OF THE DRAWING

FIG. 1 is a representation of a configuration with different devices according to the invention; and

FIG. 2 is a schematic representation of an example of a method according to the invention.

### DETAILED DESCRIPTION

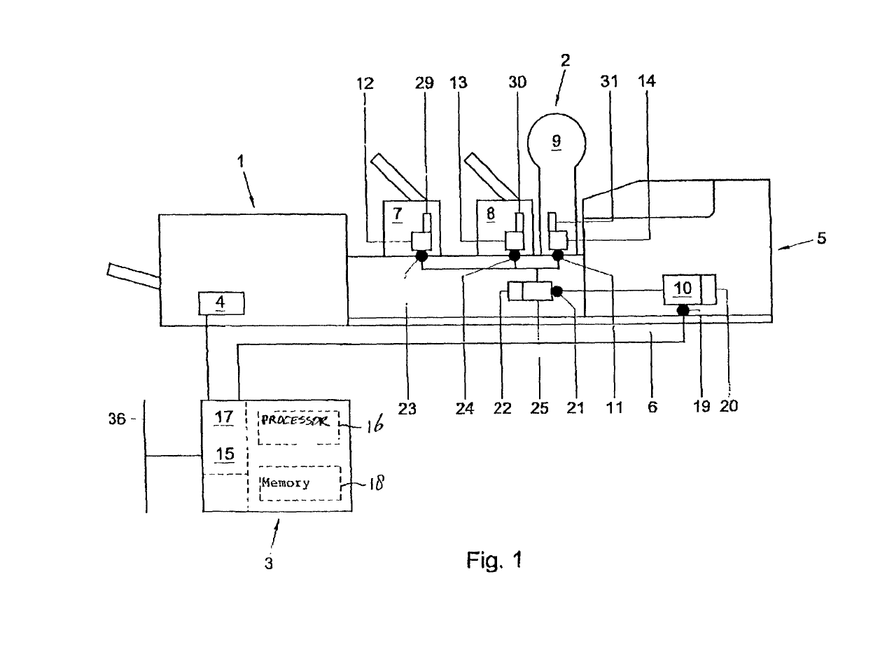

The system according to FIG. 1 is made up of a printer 1 for printing postal items, a processing device 2 for processing printed postal items into mail pieces and a control unit 3 for controlling the printer 1 and the processing device 2.

The printer is provided with a printer control 4 for controlling the print engine and the supply, feed-through and delivery functions of the printer in accordance with control instructions received from the control unit 3. The processing device 2 according to this example is made up of an inserter station 5 for enveloping documents in envelopes, and an assembly, located upstream of the inserter station 5, consisting of a transport unit 6 which carries two insert feeder stations 7, 8 and a folding station 9. The inserter station 5 is provided with a processing control unit 10 for controlling the processing of documents by the inserter station 5 and by the stations 7-9 on the transport unit 6 in accordance with control instructions received from the control unit 3. The processing control unit 10 is connected with a control unit 11 of the transport unit 6 which communicates with control units 12, 13, 14 of the stations 7-9. The control units 10-14 of the processing device 2 are arranged for distributing, in accordance with the processing instructions coming from the control unit 3, processing instructions and sequence information to the control units 10 and 12-14 of the stations, so that the correct operations are executed on the correct documents.

The control unit 3 is provided with an interface 15 coupled to a network 36. The control unit 3 is further provided with a processor 16 and an interface 17 connected with the printer 1 and with the processing device 2 for transmitting control signals to the printer 1 and the processing device 2.

It is noted that the configuration of the processing unit will naturally vary depending on the capacity and functionality desired for an application. The number of insert feeder stations, for instance, can be greater if it is desired to include a larger variety of inserts in a series of mail pieces. Further, there may be provided, for instance, a reading station, an accumulating station, an envelope printer, a franking machine, etc.

The control unit 3 further includes a memory 18 in the form of a hard disk on which software has been installed and working memory of the processor 16. Contained in the memory 18 is processing code for controlling the control unit 3.

In the proposed configuration, five devices are included which are arranged for transferring control code for controlling those devices to a control unit which in operation furnishes the instructions for the respective devices. These are the processing device 2, the transport unit 6 and the three stations 7-9.

The control unit 10 of the inserter station 5 at the same time constitutes the central control unit of the processing device 2. It is arranged and connected for controlling processing operations by the inserter station 5 and for controlling the control unit 11 of the transport unit 6. This control unit 10 has an interface 19 which is connected with the control unit 3, and memory 20. The interfaces 17, 19 can be, for instance, RS-232 serial interfaces. The memory 20 contains code for transferring, according to a communication protocol, from the memory 20 to the control unit 3, data, control code specific for control of the processing device 2 by the control unit 3, and control code arranged for control by the control unit 3 in accordance with the control code installed on the control unit 3.

When the processing device 2 is connected to the control unit 3 for the first time, the installation of the control code on the control unit 3 proceeds as follows. The control unit 3 asks the control unit 10 via a bootstrap protocol for control code. This bootstrap protocol can be pre-installed on the control unit 3 and is applicable for communication with different types of processing devices prior to the installation on the control unit 3 of control code specific for the linked-up processing device 2. The control unit 10 of the inserter station 5, according to this example, proceeds to transmit a so-called DLL with COM objects with executable software to the control unit 3. This software proceeds to execute the installation of the control code for the processing device 2 on the control unit 3. The transfer of the control code to the control unit 3 and the execution of the installation of that software, for that matter, can be carried out in many other ways, for instance by transmitting “JavaBeans” from the control unit 10 to the control unit 3.

The control unit 11 of the transport unit 6 at the same time constitutes the central control unit for the stations 7-9 placed on the transport unit 6. It is arranged and connected for controlling processing operations by the transport unit 6 and the stations 7-9 placed thereon. This control unit 11 has an interface 21 which is connected with the control unit 10 of the inserter station 10, which controls this control unit 11, and memory 22. The memory 22 contains code for transmitting, according to a communication protocol, from the memory 22 to the control unit 10 of the inserter station 5, data, control code specific for control of the transport unit 6 by the control unit 10 of the inserter station 5, and control code arranged for control of the control unit 11 of the transport unit 6 by the control unit 10 of the inserter station 5 in accordance with the control code installed on the control unit 10 of the inserter station 5.

When the transport unit 6 is connected to the inserter station 5 for the first time, the installation of the control code on the control unit 10 of the inserter station 5 proceeds as follows. The control unit 10 of the inserter station 5 asks the control unit 11 via a bootstrap protocol for control code. The control unit 11 of the transport unit 6, according to this example, proceeds to transmit a JavaBean with executable software to the control unit 10 of the inserter station 5. Using this software, next, the control code for controlling the transport unit 6 is installed on the control unit 10 of the inserter station 5.

The control units 12-14 of the stations 7-9 each have an interface 23-25 which is connected with the control unit 11 of the transport unit 6, which control unit 11 controls these control units 12-14, and memory 29-31. The memory 29-31 in each case contains code for transferring, according to a communication protocol, from the memory 29-31 to the control unit 11 of the transport unit 6, data, control code specific for the control of the respective station 7-9 by the control unit 11 of the transport unit 6, and control code arranged for control of the control unit 12-14 of the respective station 7-9 by the control unit 11 of the transport unit 6 in accordance with the control code installed on the control unit 11 of the transport unit 6.

When the stations 7-9 are placed on the transport unit 6 for the first time and are communicatively connected with the control unit 11 of the transport unit 6, the installation of the control code on the control unit 11 of the transport unit 6 proceeds as follows. The control unit 11 of the transport unit 6 asks the respective control unit 12-14 for control code via a bootstrap protocol. The control unit 12-14 called upon, according to this example, proceeds to transmit a JavaBean with executable software to the control unit 11 of the transport unit 6. Using this software, the control code for controlling the respective station 7-9 is then installed on the control unit 11 of the transport unit 6.

A particular advantage of the proposed device is that the control code in each control unit 3, 10, 11, functioning as governing control unit, automatically adjusts to modifications of the configuration of the device. If, for instance, the transport unit 6 is replaced with another transport unit (for instance a longer one with more stations), the control code required for that purpose is automatically installed in the control unit 10 of the inserter station 5, which, as stated, also constitutes the central control unit of the total processing device 2. In response thereto, the control unit 10 updates the type information of the processing device 2 and the control code for controlling the processing device 2. By the control unit 3 this change is detected as the presence of a new device. The control unit 3 thereupon sends to the control unit 10 of the inserter station 5 a request to send control code. This control code is subsequently transmitted by the control unit 10 of the inserter station 5 to the control unit 3, where it is subsequently installed. The same principle also works for the control unit 11 of the transport unit 6, which detects a change of stations connected thereto and updates the type information and control code accordingly, which in turn results in installation of that control code in the control unit 10 of the inserter station. This in turn leads to the above described procedure which is traversed if a change occurs regarding the transport unit connected to the inserter station.

Preferably, the control code for controlling the transport unit 6 and the inserter station 5 is of modular structure, so that it can easily be automatically updated for the inclusion of control code for controlling new stations. Control possibilities necessary for controlling new functionalities of new stations on the transport unit 6 can then be automatically relayed into the control code which is installed in the control unit 3.

To enable the processing device 2 to be linked to a control unit 3 and to enable realization of the communication between the processing device 2 and the control unit a for transmitting the device-specific control code to be installed, preferably generic program code for installation on the control unit is supplied with the device. This generic program code contains a communication protocol for receiving data from the device connected to an interface 17 of that control unit 3 and for processing the received data.

If the generic program code further comprises a generic processing code for automatically installing control code to be executed in accordance with the data received from the device, the adaptation of the control unit after installation of the generic program code and the connection of the processing device 2 further takes place without necessitating further user intervention.

Preferably, the generic communication protocol includes instructions for transmitting call data, which call data upon transmission to a device 2 connected to an interface 17 of the control unit 3 provoke transmission of data by the device 2. Then it makes no difference whether the processing device is connected first or the generic software is installed first. The communication for transferring the control code does not take place until after the control unit 3 has been prepared therefor and transmits the request for the control code to the linked device 2.

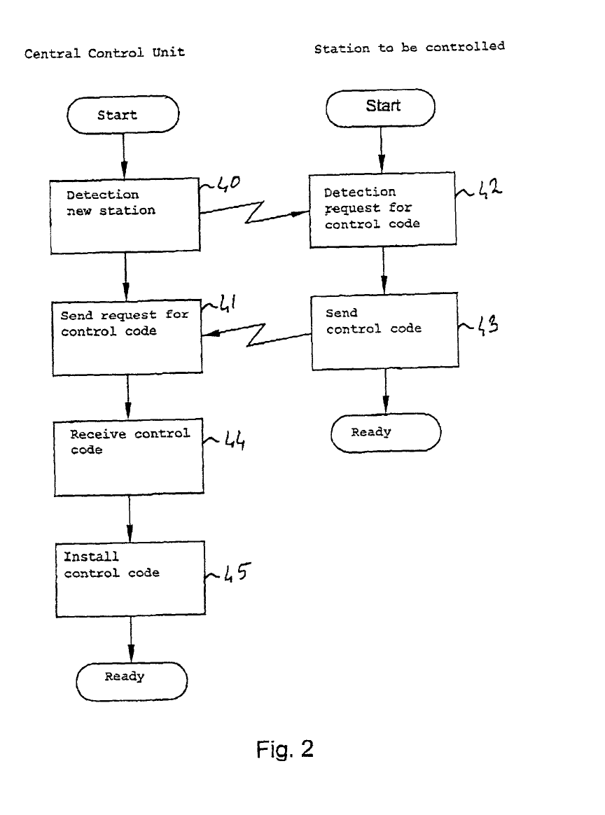

An example of the proposed method for arranging a control unit for controlling the assembly of mail pieces is further illustrated by the flow diagram represented in FIG. 2.

First of all, for instance, a station 7 is communicatively connected with the control unit 11 of the transport unit 6, functioning as governing control unit. During a configuration step which, both for the control unit 11 of the transport unit 6 and for the control unit 12 of the station 7, begins at “start”, this leads to detection of a new station (step 40) by the control unit 11 of the transport unit 6. Thereupon, the control unit 11 of the transport unit 6 transmits a request for control code to the control unit 12 of the station 7 (step 41). This request is detected by the control unit 12 of the station 7 (step 42). The control unit 12 of the station 7 thereupon reads the program code for installing the control code for controlling that station 7 from the memory 29 and transmits it to the control unit 11 of the transport unit 6 (step 43). The control unit 11 of the transport unit 6 receives this program code (step 44) and executes it, so that the control code for controlling the station 7 is installed in the control unit 11 of the transport unit 6 (step 45).

Next, the type information and the control code in the memory 22 of the control unit 11 of the transport unit 6 is updated. This leads, as described, to a corresponding procedure taking place between the control units 10 and 11 of the inserter station 5 and the transport unit 6. Thereafter, the type information and the control code in the memory 20 of the control unit 10 of the inserter station 5 is updated. This leads, as described, to a corresponding procedure taking place between the control unit 10 of the inserter station 5 and the control unit 3.

The transmission of information by the linked-up device can take place not only, as described, in response to the control unit detecting the device connected thereto and controlling the device to transmit control code, but also in response to the operation of the device for transmitting control code to the control unit, for instance with a control button or with a scanner which signals that the device is physically or electronically connected. To that end, the linked-up device can, for instance, transmit an interrupt signal to the control unit which functions as governing control unit for that device.

What is claimed is:

1. A method for arranging a control unit for controlling the assembly of mail pieces, comprising:
communicatively linking a device for performing at least one operation for the assembly of mail pieces to the control unit;
said device transmitting control code specific to that device to the control unit; and
installing said control code on the control unit.

2. A method according to claim 1, further comprising:
the control unit detecting said device connected thereto; and
the control unit controlling said device to transmit control code.

3. A method according to claim 1, further comprising:
transmitting type information from the device to the control unit;
comparing said transferred type information with type information present associated with control code present; and
the control unit, in response to the absence of transferred type information in the type information present, controlling said device to transmit control code, which transmitted control code constitutes the control code which upon reception by the control unit is installed by the control unit.

4. A method according to claim 3, wherein said type information includes data regarding the physical configuration of the device, and wherein in response to change of the physical configuration of the device the type information and the control code are brought into agreement with the changed configuration.

5. A device for physically processing postal components for the assembly of mail pieces, comprising:
a control unit for controlling at least one processing operation for the assembly of mail pieces, provided with an interface for connection to an interface of a control unit; and
a memory containing: code for transferring, according to a communication protocol, from said memory to said control unit, data, control code specific for control of the device by a control unit, and control code arranged for control by a control unit in accordance with said control code installed on said control unit.

6. A device according to claim 5, wherein said communication protocol is arranged for transferring said data in response to a question received via said interface.

7. A device according to claim 5, further comprising connections for detecting stations connected thereto and code for adapting type information and said control code in response to detected presence of stations on said connections.

8. A combination of a device according to claim 5 and generic program code for installation on a control unit, which generic program code comprises a communication protocol for receiving data from said device connected to an interface of that control unit and for processing said data.

9. A combination according to claim 8, wherein said generic program code further comprises a generic processing code for automatically installing executable control code in accordance with said data received from said device.

10. A combination according to claim 8, wherein said generic communication protocol includes instructions for transmitting call data, which call data upon transmission to a processing device connected to an interface of said control unit provoke transmission of data by said processing device.
